(19) United States
(12) Patent Application Publication
(10) Pub. No.: US 2007/0073512 A1
(43) Pub. Date: Mar. 29, 2007

(54) Conductior position inspection apparatus and conductor position inspection method

(76) Inventors: Shuji Yamaoka, Hiroshima (JP); Akira Nurioka, Hiroshima (JP); Mishio Hayashi, Saitama (JP); Shongo Ishioka, Hiroshima (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(21) Appl. No.: 10/547,084

(22) PCT Filed: Feb. 27, 2004
(86) PCT No.: PCT/JP04/02349

§ 371 Date: Jul. 10, 2006

(30) Foreign Application Priority Data
Feb. 28, 2003 (JP) 2003-102228

(51) Int. Cl. G01C 17/00; G01C 19/00; G01C 9/00; G06F 15/00

(52) U.S. Cl. 702/150

(57) ABSTRACT

Disclosed is a conductor position inspection apparatus capable of detecting where an inspection-target electric conductor is located, with a high degree of accuracy in a non-contact manner. The inspection apparatus comprises a signal supply section 510 for supplying an AC inspection signal to an inspection-target conductor 520, two sensor plates 570, 580 disposed approximately parallel to each other in the vicinity of the conductor 520, a subtracter 550 for subjecting respective detected signal values from the sensor plates to subtraction, and a divider 560 for dividing the detected signal value from a selected one of the sensor plates by the subtraction result to normalize the detected signal value from the selected sensor plate so as to detect a relative ratio between the detected signal values from the sensor plates to obtain a value X corresponding a distance between the selected sensor plate and the conductor 520, as a detection result.

### TECHNICAL FIELD

The present invention relates to a conductor position inspection apparatus and a conductor position inspection method capable of detecting a distance from an inspection-target conductor applied with an AC signal.

### BACKGROUND ART

Recent years, most of the processes for manufacturing products in large quantities have been automatically controlled. Thus, a control technique for positioning a workpiece or evaluating the positioning result has a great impact on the manufacturing cost of products and the reliability of products. The same is true of a control technique for positioning moving components of various devices.

In the conventional control technique for positioning a workpiece or evaluating the positioning result, it has been most common to provide a sensor for detecting a contact with a target component, in the vicinity of a positioning zone. This method can be used only if there is no problem about a contact with the sensor, for example, when a target component has a strength enough to withstand a contact with the sensor.

In other words, the contact sensor cannot be used if an inspection target does not have a sufficient strength, or is likely to cause deterioration in product reliability due to a contact with the sensor.

Thus, as to such an inspection target, it is required to detect a position of the inspection target in a non-contact manner. As one example, a positioning quality of the inspection target has been evaluated by irradiating the inspection target with light and detecting reflected light from the inspection target.

When an optical sensor is used, it is essential to allow light to reach the inspection target. Thus, if another member is located between the sensor and the inspection target, the position detection cannot be accurately performed.

In order to solve this problem, there has also been known a technique of detecting lines of magnetic force from a magnet provided in an inspection target to detect a position of the inspection target. However, this technique had difficulties in obtaining sufficient detection accuracy.

Further, while the above conventional techniques can detect only whether an inspection target is located at a specific limited position, they cannot detect where the inspection target is located in a given range, in a non-contact manner.

### DISCLOSURE OF THE INVENTION

In view of the above problems, it is an object of the present invention to provide a conductor position inspection apparatus and method capable of detecting where an inspection-target conductor is located, with a high degree of accuracy in a non-contact manner.

In order to achieve this object, the present invention provides the following measures.

According to a first aspect of the present invention, there is provided a conductor position inspection apparatus adapted to detect a distance from an inspection-target conductor applied with an AC signal. The conductor position inspection apparatus comprises supply means for supplying an AC inspection signal to the inspection-target conductor, at least two sensor plates disposed approximately parallel to each other in the vicinity of the inspection-target conductor, and detection means for detecting a relative ratio between respective detected signal values from the sensor plates to detect a position of the inspection-target conductor relative to a selected one of the sensor plates.

In the conductor position inspection apparatus set forth in the first aspect of the present invention, the sensor plates may be positioned parallel to each other and apart from each other by a given distance on one side of the inspection-target conductor in such a manner as to be capacitively coupled with the inspection-target conductor, and the detection means may be operable to detect a ratio between a detected signal value from a selected one of the sensor plates and a difference between respective detected signal values from the sensor plates, so as to detect a position of the inspection-target conductor relative to the selected sensor plate.

Alternatively, the sensor plates may be positioned, respectively, on both sides of the inspection-target conductor in such a manner as to be capacitively coupled with the inspection-target conductor located between the sensor plates, and the detection means may be operable to detect a ratio between a detected signal value from a selected one of the sensor plates and a summed value of respective detected signal values from the sensor plates, so as to detect a position of the inspection-target conductor relative to the selected sensor plate.

According to a second aspect of the present invention, there is provided a conductor position inspection method for use in a conductor position inspection apparatus adapted to detect a distance from an inspection-target conductor applied with an AC signal. The conductor position inspection method comprises positioning at least two sensor plates approximately parallel to each other in the vicinity of the inspection-target conductor, and detecting a relative ratio between respective detected signal values from the sensor plates to detect a position of the inspection-target conductor relative to a selected one of the sensor plates.

The conductor position inspection method set forth in the second aspect of the present invention may include positioning the sensor plates parallel to each other and apart from each other by a given distance on one side of the inspection-target conductor in such a manner as to be capacitively coupled with the inspection-target conductor, and detecting a ratio between a detected signal value from a selected one of the sensor plates and a difference between respective detected signal values from the sensor plates, so as to detect a position of the inspection-target conductor relative to the selected sensor plate.

Alternatively, the conductor position inspection method may include positioning the sensor plates, respectively, on both sides of the inspection-target conductor in such a manner as to be capacitively coupled with the inspection-target conductor located between the sensor plates, and detecting a ratio between a detected signal value from a selected one of the sensor plates and a summed value of respective detected signal values from the sensor plates, so as to detect a position of the inspection-target conductor relative to the selected sensor plate.

### BRIEF DESCRIPTION OF DRAWINGS

FIG. 1 is an explanatory block diagram showing a conductor position inspection apparatus according to a first mode of embodiment of the present invention.

FIG. 2 is an explanatory block diagram showing a conductor position inspection apparatus according to a second mode of embodiment of the present invention.

FIG. 3 is an explanatory block diagram showing a conductor position inspection apparatus according to one specific embodiment of the present invention.

FIG. 4 is an explanatory chart showing one example of a detection result based on the conductor position inspection apparatus according to the specific embodiment.

### BEST MODE FOR CARRYING OUT THE INVENTION

With reference to the drawings, a mode of embodiment of the present invention will now be described in detail.

A conductor position inspection apparatus according to a mode of embodiment of the present invention comprises at least two sensor plates made of an electrically-conductive material and adapted to be capacitively coupled with an inspection target supplied with an inspection signal (e.g. AC signal). The conductor position inspection apparatus is operable to obtain a ratio between respective inspection signals detected from the inspection target by the sensor plates, and determine a position of the inspection target in accordance with the obtained ratio.

[First Mode of Embodiment]

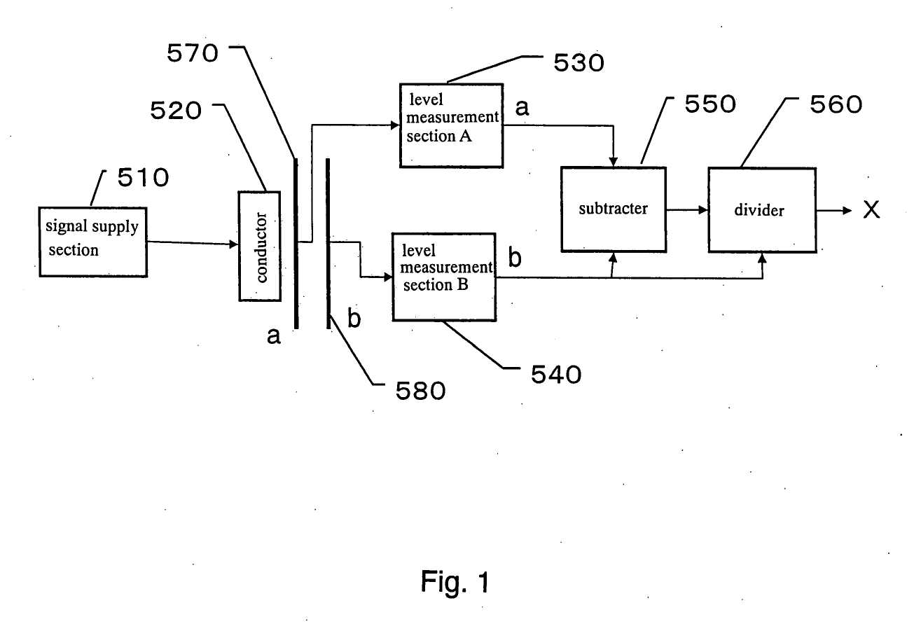

With reference to FIG. 1, a first mode of embodiment of the present invention will be described in detail below. FIG. 1 is an explanatory block diagram showing a conductor position inspection apparatus according to the first mode of embodiment of the present invention.

In FIG. 1, the reference numeral 510 indicates a signal supply section for supplying an inspection signal to an electric conductor which is an inspection target. For example, the signal supply section 510 is designed to generate an AC signal having a frequency of 1 kHz or more and a peak-to-peak voltage of 20 Vp-p. While the following description will be made on the assumption that this AC signal is used as an inspection signal, an inspection signal to be used in the first mode of embodiment is not limited to such an AC signal, but may be any other suitable signal.

The reference numeral 520 indicates an inspection target which is any electric conductor at least partly made of an electrically-conductive material, such as a conductive pattern formed on a substrate or board, a conductive wire or a conductive metal piece. The reference numeral 530 indicates a level measurement section A for measuring a detected signal level from a sensor plate a 570, and the reference numeral 540 indicates a level measurement section B for measuring a detected signal level from a sensor plate b 580.

For example, each of the level measurement section A 530 and the level measurement section B 540 may be designed to detect a peak within a given time frame and determine a measured level in accordance with the detected peak, or to obtain respective detected levels of the sensor plate a 570 and the sensor plate b 580 at the same timing and determine a measured level in accordance with the obtained detected levels.

The reference numeral 550 indicates a subtracter for calculating a difference (subtraction result) between a measured level at the level measurement section A 530 and a measured level at the level measurement section B 540. The reference numeral 560 indicates a divider for dividing a measured value from the level measurement section B 540 by the subtraction result at the subtracter 550.

Each of the sensor plate a 570 and the sensor plate b 580 is made of an electrically-conductive material. The sensor plate a 570 and the sensor plate b 580 are fixedly positioned approximately parallel to one another.

A process of measuring a position of the inspection-target conductor using the above conductor position inspection apparatus according to the first mode of embodiment will be described below.

If each of the sensor plates is capacitively coupled with the conductor, a detected signal of the sensor plate has a value inversely proportional to a distance from the conductor, in theory. However, from a practical standpoint, the influence of noises cannot be ignored, and it is significantly difficult to accurately figure out the intensity of an inspection signal supplied to the conductor. Moreover, a measurement result is largely affected by detection conditions. In consequence, a distance measurement utilizing electric capacitance has not been practically used.

With the above points in mind, the inventors conducted researches on techniques for reducing influences of conditions for supplying an inspection signal to the conductor and conditions for detecting the signal by the sensor plates so as to allow a position of conductor to be stably detected irrespective of inspection conditions. Based on knowledge gained from these researches, the inventors have finally completed the conductor position inspection apparatus as shown in FIG. 1.

Specifically, given that a measurement result at the level measurement section A 530 and a measurement result at the level measurement section B 540 are, respectively, Va and Vb, (1/Va) has a value proportional to a distance between the sensor plate a 570 and the conductor 520, and (1/Vb) has a value proportional to a distance between the sensor plate b 580 and the conductor 520.

A distance “d” between the sensor plate a 570 and the sensor plate b 580 can be considered to be equivalent to a value derived by subtracting a distance between the conductor 520 and the sensor plate a 570 positioned closer to the conductor 520, from a distance between the conductor 520 and the sensor plate b 580 positioned further away from the conductor 520. Thus, the distance “d” between the sensor plates has a value proportional to (1/Vb)−(1/Va), and thereby the following formula is satisfied: (1/Vb)−(1/Va) ∝d.

An inverse 1/{(1/Vb)−(1/Va)} of the (1/Vb)−(1/Va) can be considered to be an actually measured voltage level corresponding to “d”, and the calculation of Va/[1/{(1/Vb)−(1/Va)}] is equivalent to the normalization of Va based on “d”. Thus, an inverse of this formula can be considered to be a value proportional to a distance between the sensor plate a 570 and the conductor 520.

That is, 1/<Va/[1/{(1/Vb)−(1/Va)}]> has a value proportional to a distance between the sensor plate a 570 and the conductor 520, and this formula can be simplified as follows:

$$\begin{matrix}1 \text{/} 〈 Va \text{/} [ 1 \text{/} \{ ( 1 \text{/} Vb ) - ( 1 \text{/} Va ) \} ] 〉 = [ 1 \text{/} \{ ( 1 \text{/} Vb ) - ( 1 \text{/} Va ) \} ] \text{/} Va \\ = \{ ( Va \times Vb ) \text{/} ( Va - Vb ) \} \text{/} Va \\ = Vb \text{/} ( Va - Vb )\end{matrix}$$

This formula is achieved by the subtracter 550 and the divider 560 in FIG. 1, and an output X of the divider 560 has a value proportional to a distance between the sensor plate a 570 and the conductor 520.

This value X is based on a relative value of respective detected signal levels of the sensor plate a 570 and the sensor plate b 580. Thus, even if an inspection signal value introduced into the conductor 520 has variations, the influence of the variations can be cancelled out.

Furthermore, even if driving conditions in circuits associated with the sensor plates have variations, the influence of the variations can also be cancelled out. This makes it possible to obtain a measurement result accurately corresponding to a distance between the conductor 520 and the sensor plate a 570, with high reliability.

Thus, a detection result can be obtained with a high degree of accuracy by determining a reference value from a pre-measurement result corresponding to a distance between the conductor and the sensor plate a 570, and comparing a value X detected during an actual measurement with the reference value.

In the above conductor position inspection apparatus, the sensor plate a 570 is located between the sensor plate b 580 and the conductor 520, and a detected signal level at the sensor plate b 580 is likely to be reduced due to interposition of the sensor plate a 570. However, a rate of the reduction will never be changed, because the sensor plate a 570 electrically connected to the level measurement section A 530 is in a high impedance state. Thus, the configuration illustrated in FIG. 1 can cancel out the influence of the interposition of the sensor plate a 570 to eliminate a measurement error.

That is, even if any object, such as a conductive material, a dielectric material or an insulating material, is interposed between the sensor plate and the conductor 520, except that the object is in a low-impedance shielded state relative to the ground, the inspection apparatus in FIG. 1 can reliably obtain a measurement result X corresponding to a distance between the conductor 520 and the sensor plate a 570. This makes it possible to apply the inspection apparatus to inspection of various devices.

In addition, the inspection apparatus in FIG. 1 has no restriction on supplying an inspection signal, because even if an inspection signal level to be supplied to the conductor has variations, a ratio to be obtained as a detection result will not be changed. As to the way of supplying an inspection signal, the signal supply section may be electrically connected directly to the conductor 520 so that an inspection signal can be stably supplied thereto with the least variation.

Alternatively, an inspection signal may be supplied in a non-contact manner, for example, through an electromagnetic induction method. When an inspection signal is supplied through the electromagnetic induction method, the intensity of an inspection signal to be supplied to the conductor is likely to become unstable or have large variations. Even in this case, the inspection apparatus in FIG. 1 makes it possible to prevent an inspection result from being largely varied.

Further, an inspection signal may be supplied through a capacitive coupling formed between the signal supply section and a signal-receiving end of the conductor on the side opposite to a detection end thereof. For example, when the conductor is a conductive pattern formed on a board, the signal supply section may be capacitively coupled with a signal-receiving end of the conductive pattern to supply an inspection signal through the capacitive coupling, or the signal-receiving end may be formed as an electrode or inductor to supply an inspection signal based on electromagnetic induction.

According to the above conductor position inspection apparatus and method, a measurement result can be obtained without coming under the influence of differences in the way of supplying an inspection signal, variations in efficiency of inspection signal supply, or superposition of noise components.

[Second Mode of Embodiment]

In the first mode of embodiment, the two sensor plates are positioned approximately parallel to one another in the vicinity of one side of the conductor 520 which is an inspection target, to measure a distance between the conductor 520 and the sensor plate a 570. However, the present invention is not limited to the configuration in the first mode of embodiment, and the sensor plates may be positioned, respectively, on both sides of the conductor 520, to measure a position of the conductor as with the first mode of embodiment.

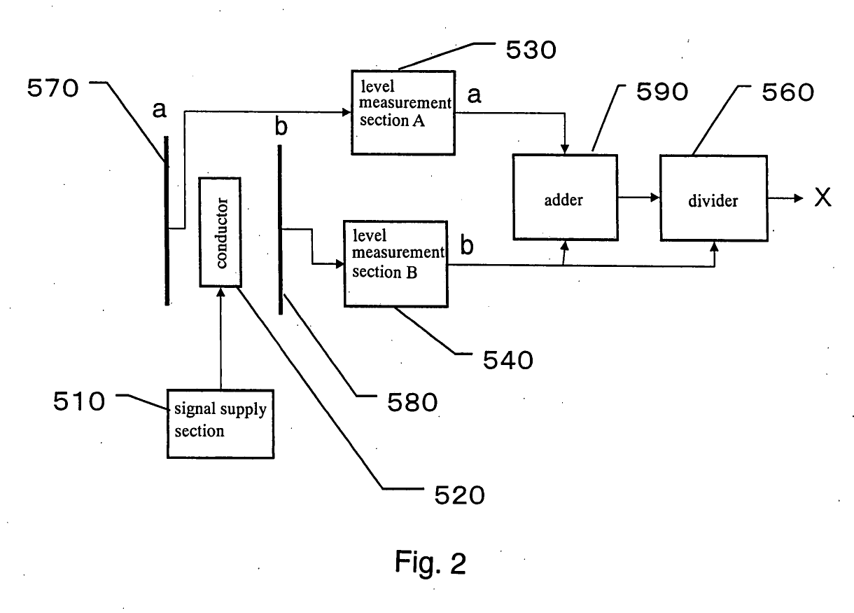

With reference to FIG. 2, a second mode of embodiment of the present invention will be described below, wherein two sensor plates are positioned, respectively, on both sides of a conductor 520. FIG. 2 is an explanatory block diagram showing a conductor position inspection apparatus according to the second mode of embodiment of the present invention. In FIG. 2, the same element or component as that in the first mode of embodiment illustrated in FIG. 1 is defined by the same reference numeral or code, and its detailed description will be omitted.

In FIG. 2, the reference numeral 510 indicates a signal supply section. For example, the signal supply section 510 generates an AC signal having a frequency of 1 kHz or more and a peak-to-peak voltage of 20 Vp-p. The reference numeral 520 indicates an inspection-target conductor. The reference numeral 530 indicates a level measurement section A for measuring a detected signal level from a sensor plate a 570, and the reference numeral 540 indicates a level measurement section B for measuring a detected signal level from a sensor plate b 580.

The reference numeral 560 indicates a divider operable to divide a measured value from the level measurement section A by an addition result at an adder 590. Each of the sensor plate a 570 and the sensor plate b 580 is made of an electrically-conductive material.

In the second mode of embodiment, the inspection-target conductor 520 is disposed in such a manner as to be interposed between the sensor plate a 570 and the sensor plate b 580 positioned in opposed relation to one another. That is, the conductor position inspection apparatus according to the second mode of embodiment is operable, when the conductor 520 is inserted in a space between the sensor plate a 570 and the sensor plate b 580, to detect an inserted position of the conductor 520.

The adder 590 is adapted to add a measured level at the level measurement section A 530 and a measured level at the level measurement section B 540.

A process of measuring a position of the inspection-target conductor using the above conductor position inspection apparatus according to the second mode of embodiment will be described below. As with the first mode of embodiment, if each of the sensor plates in the second mode of embodiment is capacitively coupled with the conductor, a detected signal of the sensor plate has a value inversely proportional to a distance from the conductor, in theory.

In the second mode of embodiment, a distance “d” between the sensor plates can be reasonably considered to be equivalent to a value derived by summing (adding) a distance between the sensor plate a 570 and the conductor 520 and a distance between the sensor plate b 580 and the conductor 520. Thus, the distance “d” between the sensor plates has a value proportional to (1/Va)+(1/Vb), and thereby the following formula is satisfied: (1/Va)+(1/Vb) ∝d.

An inverse 1/{(1/Va)+(1/Vb)} of the (1/Va)+(1/Vb) can be considered to be an actually measured voltage level corresponding to “d”, and the calculation of Va/[1/{(1/Va)+(1/Vb)}] is equivalent to the normalization of Va based on “d”. Thus, an inverse 1/<Va/[1/{(1/Va)+(1/Vb)}]> of this formula can be considered to be a value proportional to a distance between the sensor plate a 570 and the conductor 520, and can be simplified as follows:

$$\begin{matrix}1 \text{/} 〈 Va \text{/} [ 1 \text{/} \{ ( 1 \text{/} Va ) + ( 1 \text{/} Vb ) \} ] 〉 = [ 1 \text{/} \{ ( 1 \text{/} Va ) + ( 1 \text{/} Vb ) \} ] \text{/} Va \\ = \{ ( Va \times Vb ) \text{/} ( Va + Vb ) \} \text{/} Va \\ = Vb \text{/} ( Va + Vb )\end{matrix}$$

This formula is achieved by the adder 590 and the divider 560 in FIG. 2, and an output X of the divider 560 has a value proportional to a distance between the sensor plate a 570 and the conductor 520.

This value X is based on a relative value of respective detected signal levels of the sensor plate a 570 and the sensor plate 580. Thus, even if an inspection signal value introduced into the conductor 520 has variations, the influence of the variations can be cancelled out.

Furthermore, even if driving conditions in circuits associated with the sensor plates have variations, the influence of the variations can also be cancelled out. This makes it possible to obtain a measurement result accurately corresponding to a distance between the conductor 520 and the sensor plate a 570, with high reliability.

Thus, as with the first mode of embodiment, a detection result can be obtained with a high degree of accuracy by determining a reference value from a pre-measurement result corresponding to a distance between the conductor and the sensor plate, and comparing a value X detected during an actual measurement with the reference value.

[Specific Embodiment]

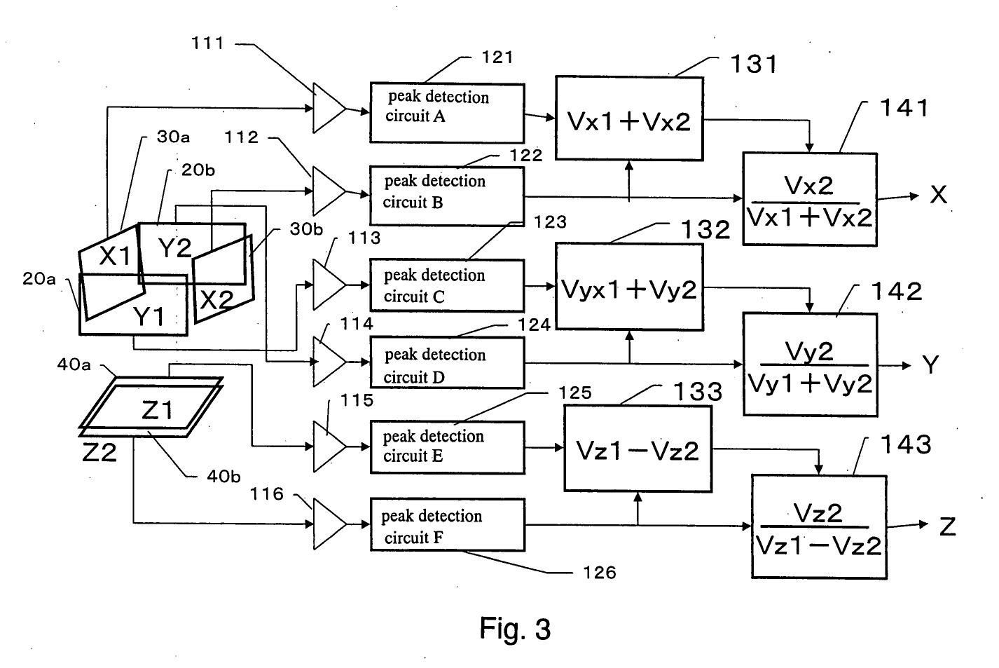

With reference to FIG. 3, one specific embodiment of the present invention will be described below. As mentioned in the above first and second modes of embodiment, the conductor position inspection apparatus of the present invention can measure a distance between the conductor 520 and the sensor plate a 570 with high reliability in a non-contact manner relative to the conductor and without coming under the influence of variations in level of an inspection signal to be supplied to the conductor.

When the sensor plates are positioned only on one side of a conductor, a position of the conductor can be reliably detected by the conductor position inspection apparatus according to the first mode of embodiment. When the sensor plates are positioned, respectively, on both sides of the conductor, a position of the conductor can be detected with a high degree of accuracy by the conductor position inspection apparatus according to the second mode of embodiment. Further, two sets of the sensor plates illustrated in FIG. 2 may be positioned, respectively, to four side surfaces of a rectangular parallelepiped-shaped conductor so as to measure a 2-dimensional position of the conductor. Furthermore, the sensor plates illustrated in FIG. 1 may be additionally positioned to a top or bottom surface of the conductor so as to measure a 3-dimensional position of the conductor.

FIG. 3 is an explanatory block diagram showing a conductor position inspection apparatus according to the specific embodiment of the present invention which is intended to achieve a 3-dimensional position measurement. This conductor position inspection apparatus will be described below with reference to FIG. 3.

In FIG. 3, the reference numerals 20a, 20b indicate a pair of Y-axis sensor plates for detecting a Y-directional position of a conductor. The reference numerals 30a, 30b indicate a pair of X-axis sensor plates for detecting an X-directional position of the conductor, and the reference numerals 40a, 40b indicate two Z-axis sensor plates for detecting a Z-directional position of the conductor.

The inspection apparatus is operable, when the conductor supplied with an inspection signal is positioned within a space surrounded by the above sensor plates, to measure a 3-dimensional position of the conductor.

The reference numerals 111 to 116 indicate six amplifiers A to F for amplifying respective detected signals from the sensor plates (20a, 20b, 30a, 30b, 40a, 40b), and the reference numerals 121 to 126 indicate six peak detection circuits A to F for detecting respective peak values of the detected signals from the sensor plates (20a, 20b, 30a, 30b, 40a, 40b).

The reference numeral 131 indicates an X-axis addition circuit operable, in response to receiving respective detected peak signal values (Vx 1, Vx 2) from the X-axis sensor plates 30a, 30b, to add the detected peak signal values and output an X-axis addition signal (Vx 1+Vx 2). The reference numeral 132 indicates a Y-axis addition circuit operable, in response to receiving respective detected peak signal values (Vy 1, Vy 2) from the Y-axis sensor plates 20a, 20b, to add the detected peak signal values and output a Y-axis addition signal (Vy 1+Vy 2). The reference numeral 133 indicates a Z-axis subtraction circuit operable, in response to receiving respective detected peak signals from the Z-axis sensor plates 40a, 40b, to output a difference (Vz 1−Vz 2) therebetween.

The reference numeral 141 indicates an X-axis division circuit operable, in response to receiving an output of the X-axis addition circuit 131 and the detected peak signal value from either one of the X-axis sensor plates (e.g. sensor plate 30b), to calculate a formula {Vx 2/(Vx 1 +Vx 2)} which has the X-axis addition signal (Vx 1+Vx 2) from the X-axis addition circuit 131 as a denominator, and the detected peak signal value (e.g. Vx 2) from either one of the X-axis sensor plates (e.g. sensor plate 30b) as a numerator.

An output of the X-axis division circuit 141 represents a relative change between respective detected signals of the X-axis sensor plates 30a, 30b. This makes it possible to cancel the influence of variations in intensity of an AC signal to be applied (supplied) from a signal supply section (see FIG. 2) to the conductor. Thus, the output of the X-axis division circuit 141 has a signal level directly corresponding to an X-directional position of the conductor in a position detection zone surrounded by the sensor plates. That is, an X-directional position of the conductor transferred into the position detection zone surrounded by the sensor plates can be detected in accordance with the output of the X-axis division circuit 141 in a non-contact manner.

The reference numeral 142 indicates a Y-axis division circuit operable, in response to receiving an output of the Y-axis addition circuit 132 and the detected peak signal value from either one of the Y-axis sensor plates (e.g. sensor plate 20b), to calculate a formula {Vy 2/(Vy 1 +Vy 2)} which has the Y-axis addition signal (Vy 1+Vy 2) from the Y-axis addition ciruit 132 as a denominator, and the detected peak signal value (e.g. Vy 2) from either one of the Y-axis sensor plates (e.g. sensor plate 20b) as a numerator.

An output of the Y-axis division circuit 142 represents a relative change between respective detected signals of the Y-axis sensor plates 20a, 20b. This makes it possible to cancel the influence of variations in intensity of the AC signal to be applied (supplied) from the signal supply section to the conductor. Thus, the output of the Y-axis division circuit 142 has a signal level directly corresponding to a Y-directional position of the conductor in the position detection zone. That is, a Y-directional position of the conductor mounted in the position detection zone can be detected in accordance with the output of the Y-axis division circuit 142 in a non-contact manner.

Therefore, an X-Y directional mounted position (2-dimensional position) of the conductor in the position detection zone can be detected in accordance with the respective outputs of the X-axis division circuit 141 and the Y-axis division circuit 142 in a non-contact manner.

The reference numeral 143 indicates a Z-axis division circuit operable to calculate a formula {Vz 2/(Vz 1−Vz 2)} which has the Z-axis difference signal (Vz 1−Vz 2) from the Z-axis subtraction circuit 133 as a denominator, and the detected peak signal value (Vz 2) from the Z-axis sensor plate 40b as a numerator.

An output of the Z-axis division circuit 143 represents a relative change between respective detected signals of the Z-axis sensor plates 40a, 40b. This makes it possible to cancel the influence of variations in intensity of the AC signal to be applied (supplied) from the signal supply section to the conductor. Thus, the output of the Z-axis division circuit 143 has a signal level proportional to a distance between the Z-axis sensor plate 40b and the conductor. That is, a Z-directional position of the conductor or how much the conductor is inserted into the position detection zone in the Z-axis direction or toward the Z-axis sensor plates 40a, 40b can be detected in accordance with the output of the Z-axis division circuit 143 in a non-contact manner.

The above circuit is configured based on the following relationship.

In the X-axis or Y-axis sensor plates, given that X or Y is n, the following formula is satisfied:

$$\begin{matrix}[ 1 \text{/} \{ ( 1 \text{/} Vn 2 ) + ( 1 \text{/} Vn 1 ) \} ] \text{/} Vn 1 = \{ ( Vn 1 \times Vn 2 ) \text{/} ( Vn 1 + Vn 2 ) \} \text{/} Vn 1 \\ = ( Vn 2 ) \text{/} ( Vn 1 + Vn 2 )\end{matrix}$$

Further, in the Z-axis sensor plates, the following formula is satisfied:

$$\begin{matrix}[ 1 \text{/} \{ ( 1 \text{/} Vz 2 ) - ( 1 \text{/} Vz 1 ) \} ] \text{/} Vz 1 = \{ ( Vz 1 \times Vz 2 ) \text{/} ( Vz 1 - Vz 2 ) \} \text{/} Vz 1 \\ = ( Vz 2 ) \text{/} ( Vz 1 - Vz 2 )\end{matrix}$$

In this embodiment, the Z-axis sensor plate 40b is located behind the Z-axis sensor plate 40a relative to the conductor, and an AC signal value to be detected from the conductor by the Z-axis sensor plate 40b is likely to slightly have the influence of the Z-axis sensor plate 40a. However, the AC signal value from the conductor can be reliably detected in a certain level without being completely blocked by the Z-axis sensor plate 40a, because each of the Z-axis sensor plates 40a, 40b is kept in a high impedance state. Thus, the relative relationship between respective detection values of the Z-axis sensor plates 40a, 40b is determined only by a position of the conductor in the position detection zone.

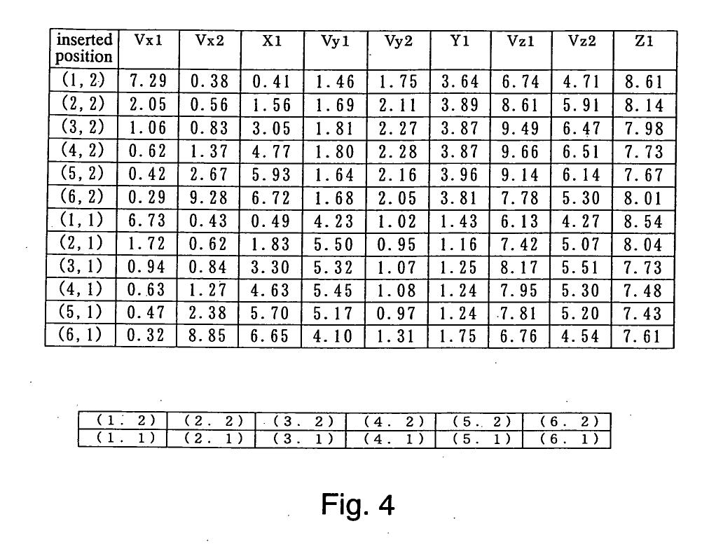

An X, Y, Z-directional position of a conductor was actually inspected using the above conductor position inspection apparatus. FIG. 4 is an explanatory chart showing one example of the detection result.

The measurement result illustrated in FIG. 4 was obtained under the conditions that X, Y-axis sensor plates are positioned to form a box shape, and Z-axis sensor plates are positioned at the bottom of the box shape, as shown in FIG. 3. As seen in FIG. 4, when the conductor is inserted into a space surrounded by the sensor plates, a specific detection result can be obtained corresponding to each inserted position of the conductor.

Thus, the conductor position inspection apparatus can determine, for example, where the conductor is located in the space surrounded by the sensor plates, in a non-contact manner relative to the conductor.

### INDUSTRIAL APPLICABILITY

As mentioned above, the present invention can provide a conductor position inspection apparatus and method capable of detecting where an inspection-target electric conductor is located, with a high degree of accuracy in a non-contact manner.

What is claimed is:

1. A conductor position inspection apparatus adapted to detect a distance from an inspection-target conductor applied with an AC signal, comprising:
supply means for supplying an AC inspection signal to said inspection-target conductor;
at least two sensor plates disposed approximately parallel to each other in the vicinity of said inspection-target conductor; and
detection means for detecting a relative ratio between respective detected signal values from said sensor plates to detect a position of said inspection-target conductor relative to a selected one of said sensor plates.

2. The conductor position inspection apparatus as defined in claim 1, wherein:
said sensor plates are positioned parallel to each other and apart from each other by a given distance on one side of said inspection-target conductor in such a manner as to be capacitively coupled with said inspection-target conductor; and
said detection means is operable to detect a ratio between a detected signal value from a selected one of said sensor plates and a difference between respective detected signal values from said sensor plates, so as to detect a position of said inspection-target conductor relative to said selected sensor plate.

3. The conductor position inspection apparatus as defined in claim 1, wherein:
said sensor plates are positioned, respectively, on both sides of said inspection-target conductor in such a manner as to be capacitively coupled with said inspection-target conductor located between said sensor plates; and
said detection means is operable to detect a ratio between a detected signal value from a selected one of said sensor plates and a summed value of respective detected signal values from said sensor plates, so as to detect a position of said inspection-target conductor relative to said selected sensor plate.

4. A conductor position inspection method for use in a conductor position inspection apparatus adapted to detect a distance from an inspection-target conductor applied with an AC signal, comprising:
positioning at least two sensor plates approximately parallel to each other in the vicinity of said inspection-target conductor; and
detecting a relative ratio between respective detected signal values from said sensor plates to detect a position of said inspection-target conductor relative to a selected one of said sensor plates.

5. The conductor position inspection method as defined in claim 4, which includes:
positioning said sensor plates parallel to each other and apart from each other by a given distance on one side of said inspection-target conductor in such a manner as to be capacitively coupled with said inspection-target conductor; and
detecting a ratio between a detected signal value from a selected one of said sensor plates and a difference between respective detected signal values from said sensor plates, so as to detect a position of said inspection-target conductor relative to said selected sensor plate.

6. The conductor position inspection method as defined in claim 4, which includes:
positioning said sensor plates, respectively, on both sides of said inspection-target conductor in such a manner as to be capacitively coupled with said inspection-target conductor located between said sensor plates; and
detecting a ratio between a detected signal value from a selected one of said sensor plates and a summed value of respective detected signal values from said sensor plates, so as to detect a position of said inspection-target conductor relative to said selected sensor plate.
